(19) United States
(12) Patent Application Publication
(10) Pub. No.: US 2003/0078739 A1
(43) Pub. Date: Apr. 24, 2003

(54) Feature list extraction from data sets such as spectra

(75) Inventors: Scott M. Norton, Sunnyvale, CA (US); Curtis A. Hastings, Arlington, VA (US); Jonathan Heller, San Francisco, CA (US)

Correspondence Address: SWANSON & BRATSCHUN L.L.C., 1745 SHEA CENTER DRIVE, SUITE 330, HIGHLANDS RANCH, CO, 80129, US

(73) Assignee: SURROMED, INC., Mountain View, CA

(21) Appl. No.: 10/265,302

(22) Filed: Oct. 4, 2002

Related U.S. Application Data
(60) Provisional application No. 60/327,624, filed on Oct. 5, 2001.

(51) Int. Cl. G06F 19/00

(52) U.S. Cl. 702/22

(57) ABSTRACT

A component list extraction method improves the quality of data extracted from a series of spectra, images, or other data sets, resulting in more accurate analysis and data mining. A series of spectra, such as mass spectra, are obtained and thresholded to distinguish peaks from noise. Conventionally, all data below the noise threshold are recorded as having zero intensity, which introduces an artificial discontinuity in the data. Instead, a composite peak list is constructed containing peaks occurring in at least a minimum number of spectra, and intensity values are recorded for corresponding peak locations in all spectra, even those having intensities below the noise threshold. The resulting intensities serve as inputs to a data mining or analysis method. The method can also be used as a peak detection method to determine components characterizing a sample type or patient population. The method is particularly useful for biological marker discovery and image processing.

### CROSS-REFERENCE TO RELATED APPLICATIONS

This application claims the benefit of U.S. Provisional Application No. 60/327,624, “Component List Extraction for Spectroscopic Data Analysis,” filed Oct. 5, 2001, incorporated herein by reference.

### FIELD OF THE INVENTION

The present invention relates generally to analysis and processing of spectroscopic and other data. More particularly, it relates to methods of feature extraction, component list generation, and data mining of spectroscopic data such as mass spectral data.

### BACKGROUND OF THE INVENTION

Biological markers (biomarkers) are measured characteristics of a patient that are correlated with normal or pathogenic biological processes or pharmacological responses to therapeutic intervention. These characteristics may have diagnostic and therapeutic utility. Spectroscopic tools can simultaneously detect and quantify multiple small molecule and macromolecular components of biological samples and are therefore ideal methods for the discovery of previously uncharacterized biomarkers. However, extracting meaningful information from spectral data can be difficult because of sample complexity and spectral noise. In a complex, noisy spectrum, it is necessary to identify the few peaks that differentiate sample types and are correlated with clinical outcomes, a process referred to as differential phenotyping. Mass spectrometry has recently been used for protein identification and is a promising tool for differential phenotyping.

Pattern recognition techniques, both statistical and machine learning, can be used to analyze spectroscopic data to identify biomarkers or classify samples and patients into disease subsets. Applicable techniques include principal component analysis, partial least squares analysis, cluster analysis, linear discriminant analysis, artificial neural networks, self-organizing maps, and genetic programming. Differences among spectra of different samples of interest (diseased and healthy patients, drug responders and non-responders) can themselves serve as biomarkers, but it is preferable to identify the molecular species causing the spectral differences. Techniques should be able to distinguish between spectral differences caused by biologically relevant sample differences and those caused by instrument noise or biological variability that is not relevant. Since differential phenotyping determines those variables contributing to cohort (e.g., disease group) separation and is not concerned with absolute quantification of the variables, algorithms need only determine the relative intensity difference necessary for cohort separation.

A problem that arises in applying data mining methods to spectroscopic data is that the raw acquired data must be converted into a data matrix for input to the algorithm. A spectrum is represented as a numeric vector in a multidimensional space in which each dimension represents a feature of the spectrum. For example, each mass-to-charge ratio (m/z) in a mass spectrum is considered a feature, and a single spectrum is represented as a vector of intensities at selected m/z values. Conversion from spectrum to vector requires an interpretation of the data that ultimately affects the results of the data mining algorithm. For example, in analyzing mass spectra, relevant peaks must be distinguished from noise and the intensity of the peaks extracted. Peak selection, whether manual or automated, is typically accomplished by determining a noise level and setting a threshold above the noise; local maxima exceeding the threshold are considered to be peaks. Data points with intensity values below the threshold are considered noise, and their intensity values recorded as zero in the data matrix. As a result, the recorded ion intensity, as a function of the detected ion intensity, appears as the discontinuous curve 10 shown in FIG. 1. Ideally, the curve would be a diagonal line 12, with recorded ion intensity being identical to detected ion intensity. The problem with the discontinuity in the curve 10 is that although it is an artifact of the peak selection method, it tends to dominate the data mining algorithm. Peaks with intensities just above and just below the threshold are seen to be qualitatively different. There is also no way to eliminate the discontinuity: regardless of where the noise threshold 14 is set, mass-to-charge ratios with intensities below the threshold always appear to the algorithm to have zero intensity.

An additional problem with selecting peaks for the data matrix is that peaks having intensities that are not significantly greater than the noise level cannot be detected accurately using standard noise filtering techniques.

There is a need, therefore, for a method for reliably selecting spectral peaks and peak intensities and other features for analysis by a data mining algorithm. There is also a need for a method that minimizes the effects of noise thresholds on the data mining algorithm.

### SUMMARY OF THE INVENTION

The present invention provides a data processing method useful for extracting magnitudes of relevant features in a plurality of data sets. Even when the features have magnitudes below a threshold used for feature selection, the extracted feature magnitudes have finite, non-zero values, thereby eliminating the effects of magnitude discontinuities on data processing algorithms.

In one embodiment, the present invention provides a data processing method in which a plurality of data sets are obtained, and a criterion, such as an intensity threshold, is applied to each data set to identify at least one feature in each. Features present in at least an occurrence threshold number of the data sets are retained, and locations corresponding to the retained features are defined. Preferably, magnitudes of the retained features are determined for each data set. Data sets can be, for example, spectra, in which features are peaks, or images, such as images of two-dimensional electrophoresis gels in which features are spots.

The present invention also provides a method for analyzing a set of spectra. Candidate peaks, whose intensity exceeds a noise threshold, are identified in each spectrum. Different spectra or spectral regions may have different noise thresholds. Candidate peaks present in at least an occurrence threshold number of the spectra are retained, and a spectral region is defined corresponding to each retained peak. For example, the spectra can be mass spectra or LC-MS spectra, in which case the spectral regions are defined by mass-to-charge ratios (m/z) and chromatographic retention times. The set of spectra can be replicate spectra associated with a particular chemical sample, and the peaks can be associated with a sample category such as a sample preparation method, sample type, or subject population.

Intensity values corresponding to the spectral regions of the retained peaks can be determined from each spectrum and assembled into a data matrix for input to a data mining algorithm, used to determine the similarity among spectra. Once the peak list is obtained, it can be used to extract corresponding intensity values from additional spectra.

Also provided by the present invention is a program storage device accessible by a processor and tangibly embodying a program of instructions executable by the processor to perform method steps for the above-described methods.

### BRIEF DESCRIPTION OF THE FIGURES

FIG. 1 is a graph of the recorded versus detected intensity of spectral peaks identified by a peak selection method in an actual and ideal case.

FIG. 2 is a flow diagram of a peak selection method of the present invention.

FIGS. 3A-3E are schematic diagrams of spectra and data illustrating the method of FIG. 2.

FIG. 4 illustrates three different methods for computing peak intensity.

FIG. 5 is a hierarchical analysis tree illustrating component lists generated according to methods of the present invention.

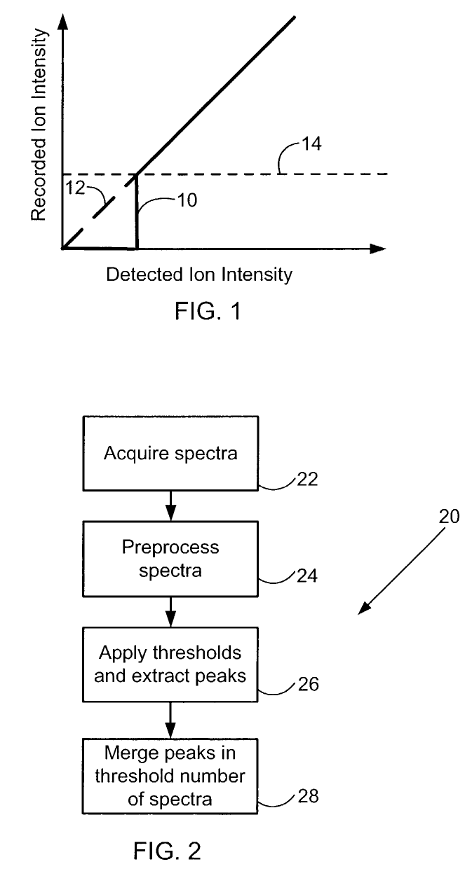

### DETAILED DESCRIPTION OF THE INVENTION

The present invention provides a method for determining the location and magnitude of relevant features in a plurality of data sets of a particular type. In general, the data sets contain features whose locations are unknown a priori and are detected by applying a criterion such as a threshold to the magnitude of signals in the data set. Whether or not particular a feature is detected depends in part upon the criterion, e.g., the threshold chosen. For example, the method can be used to determine the identity and intensity of relevant peaks in a set of spectra of a particular sample type, sample preparation protocol, or patient population. Rather than select features and associated magnitudes from each spectrum, the present invention first identifies features relevant to the entire set of data sets, then determines the corresponding magnitudes in each data set. As a result, once the set of relevant features is determined, no further features selection methods are needed. Furthermore, the compiled feature list is a more accurate and less criterion- (e.g., threshold-) dependent representation of the relevant components of a sample than the features selected in an individual data set, which can fluctuate. The method also allows for detection of relevant features whose magnitudes are comparable to the noise level. Feature magnitudes obtained with the method are used as input to data mining algorithms, in some cases for differential phenotyping purposes, and the method eliminates the effects of discontinuities in the data matrices on these algorithms.

Methods of the invention can be applied to spectra acquired by any spectroscopic technique such as mass spectrometry, optical spectroscopy, or nuclear magnetic resonance spectroscopy. Additionally, the method can be applied to any signal processing techniques that extract features by applying a predetermined set of criteria to the data, such as image processing techniques. In general, the technique provides for selection of a set of features relevant to a plurality of data sets containing signals. Features, signals that satisfy a predetermined criterion or set of criteria, are defined in part by their locations, which include approximate locations or ranges of locations. Locations can be general locations that apply to all data sets or locations specific to one or more data sets. Features have magnitudes, quantitative measures of a value associated with the signal; typically, the criterion applied to a signal is a criterion on this magnitude. For example, in the case of mass spectra, peaks are signals whose intensity values are local maxima that exceed a predetermined threshold. Peak locations are m/z values, potentially combined with chromatographic retention times or other variables. In the case of images of gels in two-dimensional gel electrophoresis, spots are clusters of signals at defined positions whose intensity values exceed a threshold.

For illustration purposes, the invention will be described with respect to mass spectrometry, in which case the features are peaks, but it will be apparent to one of ordinary skill in the art how to apply the methods to other spectroscopic and signal processing techniques. Mass spectrometry is a particularly useful technique for biological marker detection because of its high sensitivity and ability to provide detailed structural information. When mass spectra are acquired using hyphenated techniques such as liquid chromatography-mass spectrometry (LC-MS), the data are two-dimensional, with intensities being measured for values of both mass-to-charge ratio and chromatographic retention time. MS techniques performed without chromatographic or other separation yield only a single one-dimensional mass spectrum for each sample.

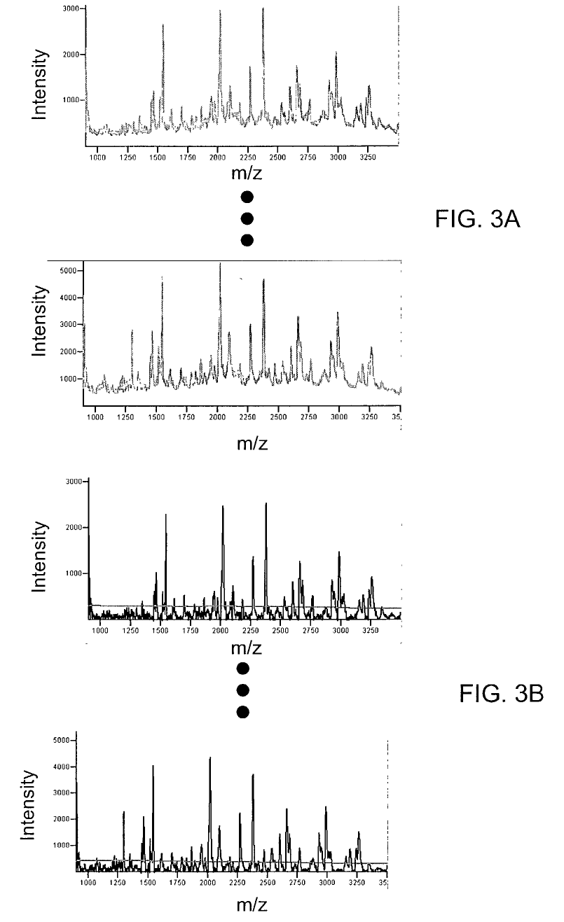

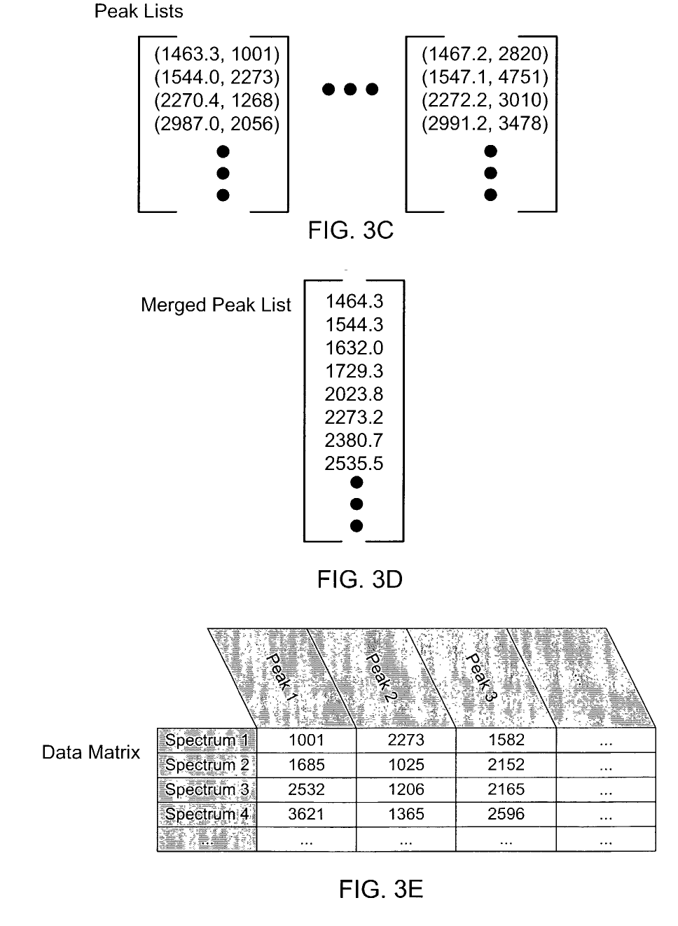

FIG. 2 is a flow diagram outlining the main steps of a peak selection method 20 of the invention. Specific implementation of the individual steps, which depends upon the particular spectroscopic or signal processing technique used, is discussed in more detail below. The method is illustrated with reference to the mass spectra and sample data of FIGS. 3A-3E. The spectra shown are one-dimensional and can correspond either to techniques such as MALDI (matrix-assisted laser desorption ionization) MS that acquire a single mass spectrum from each sample or to a single retention time for hyphenated techniques such as LC-MS.

The method 20 begins with step 22, acquiring a set of data sets, in this case spectra, from an instrument. FIG. 3A shows two of a set of spectra obtained from related samples. The spectra can be, for example, replicate spectra, obtained from different aliquots, spots, or laser pulses of the same sample, or spectra obtained from samples of different patients in the same or different cohorts. As used herein, related samples include any samples that are being compared. Visual inspection of the two spectra of FIG. 3A reveals that both spectra are quite noisy and that the relative intensities of peaks in the two spectra are different.

In step 24, the spectra are preprocessed using conventional techniques such as smoothing, baseline subtraction, and deisotoping to obtain the processed spectra shown in FIG. 3B. Spectra acquired from the instrument may have already been preprocessed somewhat; LC-MS data, for example, are typically reported by the instrument as centroided peaks rather than as continuous data. In general, preprocessing steps depend upon the type of data being analyzed. Next, the feature criterion or criteria are applied to the data sets to identify features. In this case, a noise analysis is performed on the processed data in step 26 to extract peaks from background noise. A conventional noise analysis method computes an average signal intensity and defines a threshold exceeding the average value by a multiple of the standard deviation in intensity. Local maxima above the threshold are identified as candidate peaks. Thresholds are unique to individual spectra and may vary within a spectrum. Noise thresholds are illustrated in the spectra of FIG. 3B. A set of candidate peaks whose intensity exceeds the noise threshold is extracted for each spectrum to generate a set of feature lists, in this case peak lists, in which peaks are defined by their locations, shown in FIG. 3C. For two-dimensional data such as LC-MS data, each data point in the peak list has three values: m/z, retention time, and intensity. The data shown in FIG. 3C are one dimensional and have values of m/z and intensity only.

Next, in step 28, a composite or merged feature list, such as the merged peak list shown in FIG. 3D, is constructed from the peak lists of all of the spectra. The merged peak list, also referred to as a component list, contains peak locations, i.e., m/z values or, for two-dimensional data, m/z and retention time pairs. A peak is included in the merged peak list (i.e., is retained) only if it occurs in a minimum fraction or number of the total number of spectra. The principle behind this occurrence threshold is that if different sample types are being measured, a detectable peak corresponding to a differentially expressed protein (or other molecule) appears in only a few of the spectra. For example, a relevant peak may appear only in spectra of samples from diseased patients or those who respond to drug therapy. However, multiple replicates of a single sample or single patient are usually analyzed, and the relevant peaks should appear in all (or most) of the replicate spectra. If a peak appears in only one or two replicates of a particular sample or patient, then it is likely that the detected peak is noise or an artifact. If the same peak appears in multiple spectra, particularly if those spectra are from the same sample or patient, then there is a much higher probability that the peak corresponds to a biologically relevant compound and is not merely noise. An occurrence threshold is selected based on a number of factors including the total number of samples, number of replicates of each sample, sample complexity, noise levels, and any other relevant factors.

Note that the application of an occurrence threshold serves as an additional filtering step and therefore allows the noise threshold to be set lower than would otherwise be practical. As a result, peaks with very low intensity, which would fall below conventional noise thresholds, are retained in the present invention. Because low-intensity noise is randomly distributed, unlike low-intensity peaks, the occurrence threshold filter can remove noise while retaining peaks at comparable intensity levels. The final peak list is less dependent on the particular thresholds selected than is the peak list extracted from an individual spectrum. Also note that when the present invention is used for differential phenotyping, including noise peaks in subsequent statistical analysis or data mining will have no effect on the results, because noise peaks are eliminated in statistical regression against cohorts. Thus even if a given noise peak occurs in more than an occurrence threshold number of spectra, it will not affect the statistical outcome.

In general, m/z and retention time values of a particular component fluctuate from spectrum to spectrum depending upon experimental conditions. As such, peaks that are sufficiently close in m/z and retention time presumably correspond to the same ion and are combined into a single peak in the merged peak list. For example, as shown in FIG. 3C, the m/z values 1463.3 and 1467.2 appear in two of the peak lists and are merged into a single peak at 1464.3. For one-dimensional data, peaks that are separated by less than a threshold m/z distance are combined, while for two-dimensional data, the threshold is defined by an area in m/z-retention time space. The size of the threshold window for merging is preferably predetermined. Mass-to-charge ratio and retention time values of the peaks to be merged are averaged to obtain values of m/z and retention time defining the merged peak. The standard deviations of m/z and retention time of the merged peaks are preferably also computed and stored with the peaks. Alternatively, the peaks are not actually merged, and the individual peaks corresponding to a particular component are recorded.

The merged peak list, containing mass-to-charge ratios or mass-to-charge ratio and retention time pairs that define the spectral region corresponding to each peak, makes up a component list that characterizes the related spectra. Based on this component list, a data matrix is constructed for input to a data mining algorithm. The smoothed, baseline-corrected, deisotoped, and pre-thresholded data are examined, and intensities are determined for peaks in each spectrum corresponding to the peaks in the component list. The resulting data matrix, shown in FIG. 3E, is used as input to any conventional data mining algorithm. Note that the determined intensities include intensities that are below the noise thresholds of some of the spectra. Without the present invention, these peaks would not have been identified in some of the raw spectra, leading to zero values in the data matrix.

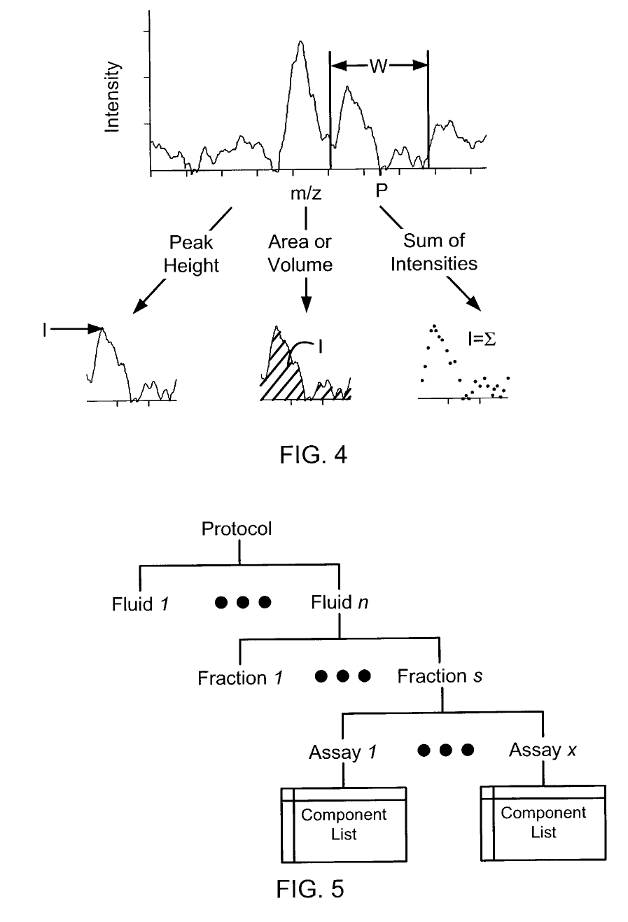

Peak intensity values can be represented in the data matrix in a variety of ways, as illustrated in FIG. 4. In all cases, the region of the spectrum examined is a region centered on the component list peak, labeled P in FIG. 4, and extending a distance W defined (preferably) by the standard deviations of the retention time and mass-to-charge ratios (e.g., a multiplicative factor of the standard deviations). Alternatively, the region can be selected based on the known region of each individual spectrum corresponding to the component. In the simplest case, the intensity is simply the maximum value (peak height) within the window. Alternatively, the intensity is the integrated area or volume under the spectrum within the window. The computed intensity can instead be the sum of all intensity values in the window surrounding the component list peak. It may be beneficial to construct multiple data matrices using different intensity determination methods and compare the results of the data mining technique to determine the best intensity measurement for the particular data set.

Although the method steps can be implemented using any suitable technique, preferred techniques are described below for analyzing LC-MS and MALDI spectra. Of course, different techniques are applicable to different types of spectroscopy. For one-dimensional MALDI mass spectra, baseline subtraction, part of the preprocessing step 24, is preferably performed by a moving window technique. A window of fixed m/z length is centered on each data point, and a line is drawn connecting the lowest data points on either side of the center point. The point at which the line crosses the center of the window is taken to be the baseline-corrected value of the center point. The window is shifted point by point so that each data point is similarly examined.

The noise threshold is preferably computed in step 26 using a peak-to-peak noise computation method, which is relatively insensitive to outliers. As with the baseline correction technique, a moving window is applied to the data set. Within the window, a difference is computed between the highest and lowest intensity values. The window is moved until it has been centered on each value of m/z or (for two-dimensional data) m/z and retention time. The most frequently occurring value of intensity difference is selected to be the peak-to-peak noise value, with the threshold set at this value above baseline. For normally distributed noise, the peak-to-peak noise is a multiplicative factor of the standard deviation of the intensity, where the multiplicative factor is a function of the window size.

Noise characteristics typically depend on the ionization and detection methods, as well as the system electronics. In some cases, the noise declines at higher values of mass-to-charge ratio. To address this, different noise thresholds are computed for different regions of a spectrum. The threshold can be assigned to the entire region or, preferably, the threshold is assigned to the center of the region and the center points of all regions interpolated to generate a continuous noise threshold for the entire spectrum.

An alternative method of noise analysis is simply to define a noise threshold at an intensity somewhere between the lowest and highest intensity values of the entire spectrum. This method is the preferred method for two-dimensional data such as LC-MS data in which the intensities have already been centroided by the instrument in the mass dimension. In this method, the data points are sorted by intensity, and the intensity value below which one-third of the points occur (the one-third median) is taken to be the noise level. The location of the threshold can be varied (e.g., one-half, one-quarter) as desired.

The peak merging in step 28 can be performed in a number of different ways. In general, any suitable clustering method can be used that does not require a priori knowledge of the number of clusters. In a preferred method, m/z values or m/z and retention time pairs from individual peak lists are combined into a master list that is sorted by retention time and m/z ratio. The two closest peaks (in retention time) are identified and, if they differ in m/z by less than a predetermined value, are merged into a single peak at an average m/z and retention time. The process is repeated until the distance between the two closest peaks exceeds the distance threshold for merging. Averages are preferably weighted to account for previous merges. Standard deviations of m/z and retention time are also preferably computed for all merged peaks. Merging can also be performed by sorting in m/z and applying a retention time distance threshold. For one-dimensional data, both sorting and thresholding are based on m/z values.

The final merged peak list represents a particular sample type, sample preparation protocol, fluid fraction, assay type, or other category of interest. In general, a sufficient number of spectra is required of a particular cohort or sample category for the list to be an adequate representation. Once a list is derived, it can be applied to newly obtained spectra of the appropriate type to extract a data matrix. FIG. 5 shows a hierarchical analysis tree illustrating this concept. Each node of the tree represents a sample type with associated component list that is the union of the component lists of the child nodes. Higher levels of the tree contain the broadest sample descriptions, while lower levels correspond to more precisely defined samples. In FIG. 5, the protocol at the highest level node applies to different extracted biological fluids, each of which is separated (e.g., by molecular weight) into multiple fractions having distinct component lists. Different assays performed on a single fraction identify distinct component subsets.

The chemical structures corresponding to peak list components can be identified using conventional methods. If desired, the component lists can be edited based on biological knowledge to remove or add components.

Data matrices generated according to methods of the invention serve as input to a data mining algorithm. As used herein, a data mining algorithm includes any data analysis performed on data from one or more data sets (e.g., spectra). One useful machine learning technique for analyzing spectral data is principal component analysis (PCA), a technique in which data dimensionality is reduced by introducing new variables that are linear combinations of the original variables and represent the greatest variance of the data measures. Although PCA can be used as a pre-processing step before applying classification techniques to spectra, it can also be used alone if sufficient dimensionality reduction is achieved. If each spectrum is represented as a point in a two- or three-dimensional principal component space, distances between spectra can be visualized and measured easily, and clusters in data become evident. According to the present invention, the input to the PCA algorithm is a data matrix constructed using the independent peak identification and quantification method described above. The method reduces the artificially dominating effect of zero intensity values on the algorithm, resulting in much better data reduction and classification. Similar benefits are found in clustering methods such as hierarchical clustering analysis. Note that although the term “data matrix” is used, the data can be in any suitable format for input to the algorithm.

Clusters can be used to classify subjects or sample preparation methods. For example, clusters reveal whether differences between spectra result from true biological variability or from instrument noise or sample preparation methods. Consider spectra obtained from a single fluid sample and from different fluid samples. Ideally, spectra from the same sample are similar and therefore close together in principal component space, while spectra from different samples are significantly farther apart. The relative distances therefore represent the ability of the mass spectrometric assay to distinguish biological variability from variability arising from other sources. Once it has been confirmed that an assay protocol illuminates primarily biological variability, the same protocol can be applied to unknown samples. The resulting extracted data matrix is analyzed and compared to previous data to classify the sample and spectrum.

The analysis can also be applied to separation methods. One way to reduce the complexity of analyzed biological samples and their spectra is to extract particular components from a fluid and analyze only the extracted components by mass spectrometry. Solid-phase micro-extraction or nano-extraction uses chemically derivatized particles such as polystyrene beads to extract fluid components from a complex sample. The beads can be separated from the remaining fluid for analysis. Although the solid particles can be derivatized with highly specific extraction phases such as antibodies, they can also be derivatized with functional groups that interact with a broad range of compounds. Ideally, a set of functional groups is used that extracts relatively non-overlapping classes of compounds from the fluid. PCA using data matrices constructed according to methods of the present invention can be used to confirm whether differently derivatized particles are extracting substantially different classes of compounds. Again, spectra of samples extracted using different capture chemistries should be separated by a greater distance in principal component space than spectra of samples extracted by the same extraction chemistry. Different extraction chemistries can be tested to find a set that leads to significantly different spectra and therefore assays the entire fluid composition.

As will be apparent to those of skill in the art, the benefits conferred by the methods of the invention apply to any data mining algorithm that requires as input a data matrix representing a set of data sets such as spectra or images. The problems of intensity discontinuities extend to any number of techniques, including those not listed herein, and the present invention can be used to prepare data input for any such methods. Similarly, the invention is useful not only for mass spectrometry, but for any analytical method used for differential phenotyping or other classification and clustering techniques. Many different spectroscopic techniques are used for biological marker discovery and identification, including nuclear magnetic resonance, infrared, Raman, and ultraviolet/visible spectroscopies, among others.

In alternative embodiments, the invention is used for non-spectroscopic methods (e.g., image processing or signal processing) in which features are selected in a set of data sets by applying a set of predetermined criteria to the data sets. Features occur at particular locations of the data set and have magnitudes. In these embodiments, features identified in the different data sets are merged into a master feature list when they are present in at least an occurrence threshold number of data sets. The constructed feature list is then applied to the sets of data to extract magnitudes of the features. Extracted magnitudes can be used as input to a data mining or other analysis algorithm. Subsequently, the feature list can be applied to newly-obtained data sets to extract magnitudes. The method is particularly advantageous for differential phenotyping applications in which samples represent cohorts or other sample types, in which case a statistically relevant merged feature list can be constructed.

One image processing example to which the method can be applied is 2D gel electrophoresis, for which image processing is currently performed to quantify spots corresponding to separated peptides. In this case, features are extracted by applying an intensity threshold to the image and identifying clusters of signal exceeding the intensity threshold. These clusters are spots of separated sample components occurring at particular positions of the gel. A merged feature list is then constructed for the entire set of gels by applying an occurrence threshold. Each gel can be analyzed subsequently to quantify the spots corresponding to regions of the merged feature list.

Although not limited to any particular hardware configuration, the present invention is typically implemented in software by a system containing a computer that obtains data sets from an analytical instrument or other source. The computer implementing the invention typically contains a processor, memory, data storage medium, display, and input device (e.g., keyboard and mouse). Methods of the invention are executed by the processor under the direction of computer program code stored in the computer. Using techniques well known in the computer arts, such code is tangibly embodied within a computer program storage device accessible by the processor, e.g., within system memory or on a computer-readable storage medium such as a hard disk or CD-ROM. The methods may be implemented by any means known in the art. For example, any number of computer programming languages, such as Java, C++, or LISP may be used. Furthermore, various programming approaches such as procedural or object oriented may be employed. It is to be understood that the steps described above are highly simplified versions of the actual processing performed by the computer, and that methods containing additional steps or rearrangement of the steps described are within the scope of the present invention.

It should be noted that the foregoing description is only illustrative of the invention. Various alternatives and modifications can be devised by those skilled in the art without departing from the invention. Accordingly, the present invention is intended to embrace all such alternatives, modifications and variances that fall within the scope of the disclosed invention.

What is claimed is:

1. A data processing method comprising:
obtaining a plurality of data sets;
applying a criterion to each data set to identify at least one feature in said data set;
retaining features present in at least an occurrence threshold number of said data sets; and
defining a location corresponding to each retained feature.

2. The method of claim 1, further comprising determining magnitudes of said retained features in at least one of said data sets.

3. The method of claim 1, wherein said criterion comprises an intensity threshold.

4. The method of claim 1, wherein said data sets comprise spectra and said features comprise peaks.

5. The method of claim 1, wherein said data sets comprises images.

6. The method of claim 5, wherein said images are images of electrophoresis gels and said features comprise spots.

7. A method for analyzing a set of spectra, comprising:
in each spectrum, identifying candidate peaks;
retaining candidate peaks present in at least an occurrence threshold number of said spectra; and
defining a spectral region corresponding to each retained peak.

8. The method of claim 7, wherein said spectra are mass spectra and said spectral region is defined by mass-to-charge ratios.

9. The method of claim 8, wherein said spectra are LC-MS spectra and said spectral region is further defined by chromatographic retention times.

10. The method of claim 7, wherein said set of spectra comprises replicate spectra associated with a particular chemical sample.

11. The method of claim 7, wherein said candidate peaks have intensity values exceeding a noise threshold.

12. The method of claim 11, wherein each of at least two different candidate peaks of a particular spectrum has an intensity value exceeding a different noise threshold.

13. The method of claim 7, further comprising determining intensity values in at least one spectrum corresponding to said spectral regions.

14. The method of claim 13, further comprising assembling said intensity values into a data matrix for input to a data mining algorithm.

15. The method of claim 14, further comprising determining the similarity among said spectra using said data mining algorithm.

16. The method of claim 13, further comprising determining additional intensity values corresponding to said identified peaks in an additional spectrum, wherein said additional spectrum is not in said set of spectra.

17. The method of claim 7, wherein said peaks are associated with a sample category.

18. The method of claim 17, wherein said sample category comprises a sample preparation method.

19. The method of claim 17, wherein said sample category comprises a sample type.

20. The method of claim 17, wherein said sample category comprises a subject population.

21. A program storage device accessible by a processor, tangibly embodying a program of instructions executable by said processor to perform method steps for a data processing method, said method steps comprising:
obtaining a plurality of data sets;
applying a criterion to each data set to identify at least one feature in said data set;
retaining features present in at least an occurrence threshold number of said data sets; and
defining a location corresponding to each retained feature.

22. The program storage device of claim 21, wherein said method steps further comprise determining magnitudes of said retained features in at least one of said data sets.

23. The program storage device of claim 21, wherein said criterion comprises an intensity threshold.

24. The program storage device of claim 21, wherein said data sets comprise spectra and said features comprise peaks.

25. The program storage device of claim 21, wherein said data sets comprises images.

26. The program storage device of claim 25, wherein said images are images of electrophoresis gels and said features comprise spots.
